(19) United States
(12) Patent Application Publication
(10) Pub. No.: US 2022/0304278 A1
(43) Pub. Date: Sep. 29, 2022

(54) PET TOY

(71) Applicant: Doskocil Manufacturing Company, Inc., Arlington, TX (US)

(72) Inventors: Josiah WILHELM, Fort Worth, TX (US); Ronald BAGLEY, Dallas, TX (US); Sunil PINTO, Arlington, TX (US); Jill JACKSON, Fort Worth, TX (US)

(21) Appl. No.: 17/461,079

(22) Filed: Aug. 30, 2021

Related U.S. Application Data
(60) Provisional application No. 63/164,606, filed on Mar. 23, 2021.

(51) Int. Cl. A01K 15/02; G10K 15/04

(52) U.S. Cl. CPC A01K 15/025; G10K 15/04

(57) ABSTRACT

A pet toy includes a core having interior portion and defining an elongate channel along a surface of the core, a channel-shaped insert received into the elongate channel and overlying the elongate channel, a cover attached to the channel-shaped insert, and overlying portions of the core that are not covered by the channel-shaped insert such that the core is enclosed cooperatively by the channel-shaped insert and the cover, and a noise making device disposed within the interior portion of the core.

### CROSS-RELATED APPLICATIONS

This application claims priority to U.S. Provisional Patent Application No. 63/164,606 filed on Mar. 23, 2021 which is hereby incorporated herein by reference.

### BACKGROUND

### Field of the Invention

The present invention relates to a pet toy. In particular, the present invention relates to a pet toy including a sound making device that activates in response to movement and can provide an erratic unpredictable bounce.

### Background of the Invention

Recreational balls for competitive and fitness activities, for general play activities, and for pet play and training activities are known in the art, and provide endless hours of recreation for users. Typically, such balls are designed to produce a predictable and consistent bounce. Some conventional balls have been designed to produce less predictable behavior, for example, balls having multiple planar sides, off-center weighting, or the like. Often, balls or pet toys provide a squeaker device that attempt to engage an animal's interest by emitting a squeaking noise when compressed.

For an example of one type of conventional ball see U.S. Pat. No. 8,683,958, the entire contents of which are herein incorporated by reference.

### SUMMARY

It has been found that it is desirable to provide a ball that exhibits erratic or unpredictable behaviors. For example, it may be desirable to introduce chance into a game, or to develop and test a user's reflexes and reaction times. Similarly, it may be desirable to introduce erratic behavior when playing and/or training pets, both to keep the pet's attention and enjoyment of the game, and to keep the pet's reflexes sharp. The embodiments described herein can exhibit erratic behavior.

Additionally, it has been found that many animals enjoy playing with sound toys. Most conventional toys contain simple squeakers. It has been found that exciting sounds are needed to spark an animal's (e.g., a dog's) interest and encourage them to play. The embodiments described herein can emit exciting and unpredictable sounds.

Further, it has been found that it is desirable to have a toy that is suitable for both indoor play and for outdoor play. For example, a ball suitable for indoor play is typically relatively soft, lightweight, and compliant. A ball suitable for outdoor play will typically have enough mass to withstand at least light breezes, and have a relatively rugged outer surface. The embodiments described herein meet both these requirements.

In view of the state of the known technology, a first aspect of the present disclosure is to provide a pet toy that includes a core having an interior portion and defining an elongate channel along a surface of the core, a channel-shaped insert received into the elongate channel and overlying the elongate channel, a cover attached to the channel-shaped insert, and overlying portions of the core that are not covered by the channel-shaped insert such that the core is enclosed cooperatively by the channel-shaped insert and the cover, and noise making device disposed within the interior portion of the core.

In a second aspect of the present disclosure according to the first aspect, the noise making device is an elongate tube.

In a third aspect of the present disclosure according to the first or second aspect, the noise making device includes a noise maker disposed within the elongate tube.

In a fourth aspect of the present disclosure according to any of the previous aspects, the noise maker includes openings in a surface thereof for the passage of air.

In a fifth aspect of the present disclosure according to any of the previous aspects, the noise maker includes a cylindrical plastic member disposed with a ring.

In a sixth aspect of the present disclosure according to any of the previous aspects, the noise maker is configured to longitudinally slide within the elongate tube.

In a seventh aspect of the present disclosure according to any of the previous aspects, the noise maker is configured to move relative to the elongate tube due to gravity.

In an eighth aspect of the present disclosure according to any of the previous aspects, the noise making device includes a cover member.

In a ninth aspect of the present disclosure according to any of the previous aspects, the channel-shaped insert includes an opening and the noise making device is disposed at the opening.

In a tenth aspect of the present disclosure according to any of the previous aspects, the channel-shaped insert defines a spherical curve.

In an eleventh aspect of the present disclosure according to any of the previous aspects, the cover comprises a plurality of woven panels.

In a twelfth aspect of the present disclosure according to any of the previous aspects, the channel-shaped insert further comprises flanges, and the cover is attached to the channel-shaped insert by stitching to the flanges.

In an thirteenth aspect of the present disclosure according to any of the previous aspects, the cover is attached to the core with an adhesive.

In a fourteenth aspect of the present disclosure according to any of the previous aspects, the adhesive comprises a heat-activated adhesive substrate.

In a fifteenth aspect of the present disclosure according to any of the previous aspects, the channel-shaped insert defines a channel having a varying width.

In an sixteenth aspect of the present disclosure according to any of the previous aspects, the channel-shaped insert has a textured surface that improves the gripping properties of the insert.

In a seventeenth aspect of the present disclosure according to any of the previous aspects, the core defines a center void.

In a eighteenth aspect of the present disclosure according to any of the previous aspects, the cover is a first color and the channel-shaped insert is a second color that is complementary to the first color.

### BRIEF DESCRIPTION OF THE DRAWINGS

The invention will be explained in more detail hereinafter with reference to the drawings.

FIG. 1 illustrates a pet toy according to an embodiment of the invention;

FIG. 2 illustrates a top perspective view of the pet toy according to FIG. 1;

FIG. 3 is an exploded view of the pet toy of FIG. 1;

FIG. 4 is a cross sectional view of the toy of FIG. 1;

FIG. 5 is a cross sectional view of the noise making device;

FIG. 6 is a cross sectional view of the noise making device after traversing along the tubular member;

FIG. 7 is a top view of the noise maker for the noise making device;

FIG. 8 is a bottom view of the lid of the noise making device; and

FIG. 9 illustrates the pet toy of FIG. 1 in use.

### DETAILED DESCRIPTION OF THE EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

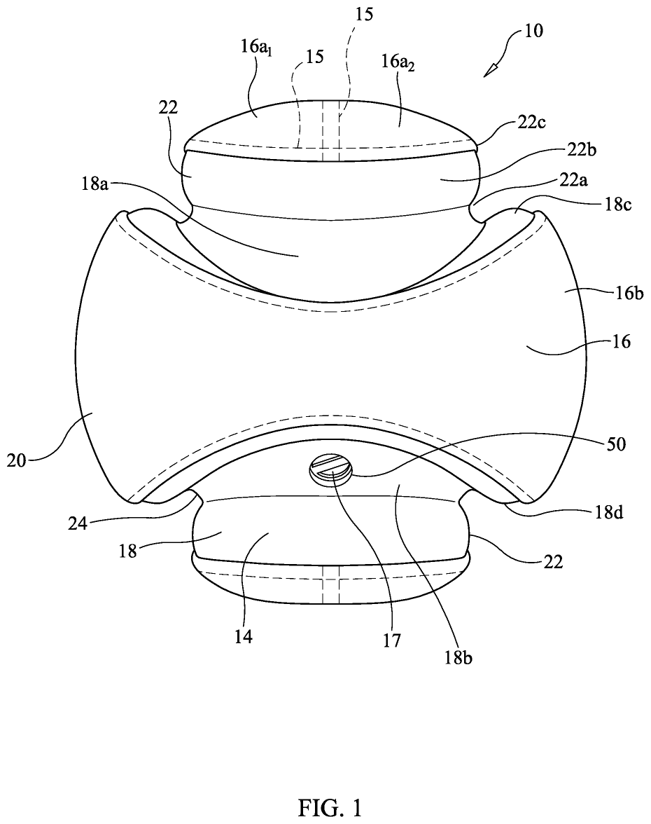

Referring initially to FIGS. 1-3, a pet toy 10 is illustrated in accordance with a an embodiment. The pet toy 10 includes a core 12, a channel assembly 14, a cover 16 attached to the channel assembly 14, and a noise making device 17. As discussed in more detail below the core 12, the cover 16, the channel assembly 14, and noise making device 17 form an embodiment that is generally spherical and basically forms a ball that includes a channel 18 or reverse welt defining a spherical-curve-shaped channel in the pet toy 10. The terms “channel” and “reverse welt” are used interchangeably herein to refer to an elongate recess (channel) defined in the surface 20 of the pet toy 10. Examples of suitable spherical curves include Seiffert's spherical spiral, a spherical helix, a spherical spiral, etc. The channel 18 in the current embodiment defines a single closed spherical curve sometimes referred to as a “baseball curve” due to its similarity to the shape of a baseball seam.

Although the baseball curve-shaped channel 18 of the disclosed embodiment is currently preferred, and produces an aesthetically-pleasing ball with desirable functional aspects as discussed below, other channel curve shapes are contemplated, including, for example, one or more parallel or intersecting longitudinal and/or latitudinal channels. Alternatively, channels segmenting the surface into particular shapes, for example, triangular, circular, or square segments, can be distributed over the surface of the pet toy 10, and may partition the outer surface into more than two segments.

In some embodiments the outside diameter of the pet toy 10 is between four inches and twenty-four inches, and more preferably between five inches and twelve inches.

The channel has a depth and a width, that are selected to allow a user or animal to grasp the pet toy 10 by inserting finger tips into the channel and grasping opposing portions of the sidewall of the channel. The channel depth and width can similarly be deep enough and wide enough to allow a pet to carry the pet toy 10 using a biting grasp that engages the channel, at least on one side.

The channel can have a depth of between 0.3 inches and 1.8 inches, and more preferably between 0.4 inches and 1.2 inches. The depth of the channel can be scaled with the outside diameter of the pet toy 10. For example, the channel can be configured to have a depth of between 7% and 20% of the pet toy 10 outside diameter. Although in the current embodiment the channel depth is relatively constant, it is contemplated that the depth can vary.

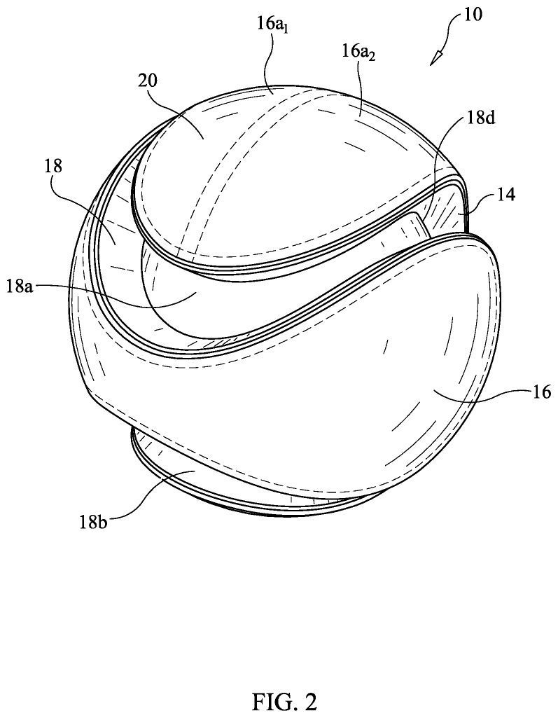

The width of the channel 18 can vary along its length. In addition to aesthetic considerations, the variable width of the channel 18 provides the user and/or pet with options for grasping the pet toy 10, increasing the play value. That is, as shown for example in FIGS. 1 and 2, the channel 18 can have a maximum width at an area in which the channel 18 converges (i.e., at an area in which a first part 18a of the channel 18 is closest to a second part 18b of the channel 18) and a minimum width at an area in which the channel 18 diverges (i.e., at an area in which a third part 18c of the channel 18 is farthest from a fourth part 18d of the channel 18).

In one embodiment, the width of the channel at the surface of the pet toy 10 may vary from a minimum width between 0.2 inches on smaller pet toys 10 (at third part 18c and fourth part 18d) and 1.2 inches on larger pet toys 10 to a maximum width between 1.0 inches on smaller pet toys 10 and 3.0 inches on larger pet toys 10 (at first part 18a and second part 18b). The minimum and maximum widths of the varying-width channel can also be scaled with the circumference of the pet toy 10. For example, the channel can be configured to have a width at the pet toy 10 outer surface 20 that varies between a minimum width (at third part 18c and fourth part 18d) between 4% and 8% of the circumference, and a maximum width (at first part 18a and second part 18b) between 8% and 12% of the pet toy 10 circumference.

The width of the channel 18 will typically also vary radially, for example, the width of the channel at the outer surface 20 of the pet toy 10 will typically be different from the width of the channel at the floor of the channel. The channel sidewalls can converge radially outwardly such that the channel is narrower at its opening than at its floor (“negative draft”) which can make it easier to grasp. Conversely, the channel sidewalls may converge, to produce a negative draft. As shown in FIG. 1, the upper portion 22 of the side wall 24 bulges causing the width of the channel 18 to be narrow at the top of the channel 18 relative to a lower portion of the channel 18. Further the bulging of the upper portion 24 forms an arcuate configuration that causes the width of the channel 18 to vary along the height of the channel 18. That is the upper portion bulges outwardly at a first end 24a thereof to a maximum bulge at the central portion 24b and then curves inwardly at a second end 24c thereof. This configuration facilitates gripping of the pet toy by both a hand of an owner and the teeth of a pet.

It is also noted that although the channel 18 is illustrated with curved sidewalls, in one current embodiment the sidewalls are flat or bulge outwardly, having a positive draft near the bottom of channel 18.

The channel 18 can partition the outer surface 20 into two segments or panels 20a and 20b having varying widths. The varying width segments 20a and 20b allow the user (or pet) to selectively grasp the pet toy 10 with different grips by grasping the pet toy 10 in different locations.

The channel 18 defined on the surface 20 of the pet toy 10 provides advantages for enhancing play with the pet toy 10 that are not found in prior art balls. For example, as discussed above, the deep channel 18 provides unique grasping functionality for either a human hand or for a pet's teeth. In particular, the variable width and curved configuration of the channel 18 results in a continuously variable bite/grip zone. This makes the pet toy 10 easy to grip in different orientations, and to easily accommodate different hand sizes and different jaw sizes.

Also, the channel 18 will produce unique rolling characteristics for the pet toy 10. At higher rolling speeds, the pet toy 10 will roll in a manner approximating the rolling characteristics of a spherical ball. However, the rolling tends to become more erratic and less predictable as the rolling speed decreases. The unique predictable/unpredictable rolling characteristics provides a user with fast reaction training for sports such as soccer, and provides animal mimicking behavior for training and exercising pets, for example, herding dogs. The erratic behavior also provides new gaming modes, for example, games involving rolling or throwing the pet toy 10 towards a desired target, and scoring on the basis of nearness to the target when the pet toy 10 stops.

For pet or work animal training, the reverse welt channel 18 also provides a convenient floor or bottom surface that can be coated with useful training aids (e.g., peanut butter, scent materials, etc.). The large and deep channel 18 is also easy to clean.

The channel 18 in some embodiments can produce an audible signal, for example, a whistle or white noise during flight, generated by air flow through the channel 18. The signal will provide auditory cues for users and/or pets during play when the pet toy 10 is in flight. The auditory cues may assist the user or pet in tracking the pet toy 10.

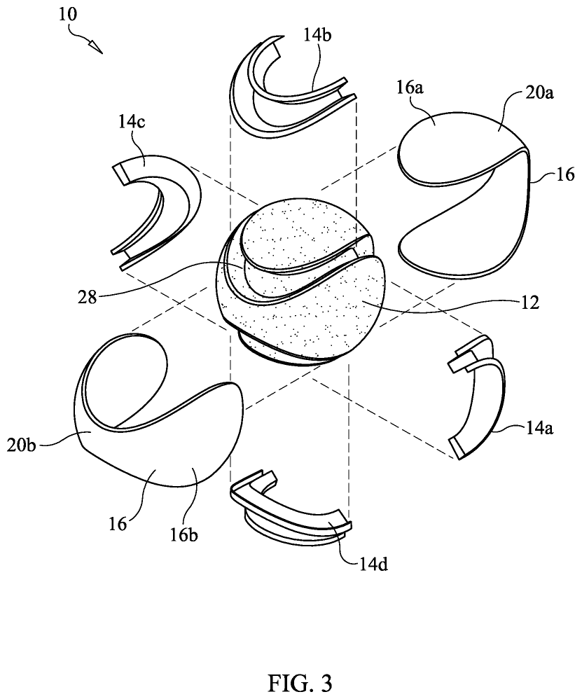

As specifically illustrated in FIG. 3, in one embodiment, the toy 10 includes the core 12, a channel assembly 14 that is attached to and retained on the core 12, the cover 16 fixed to the outer surface 20 of the core 12, and the noise making device 17 disposed in an interior portion 26 of the core 12.

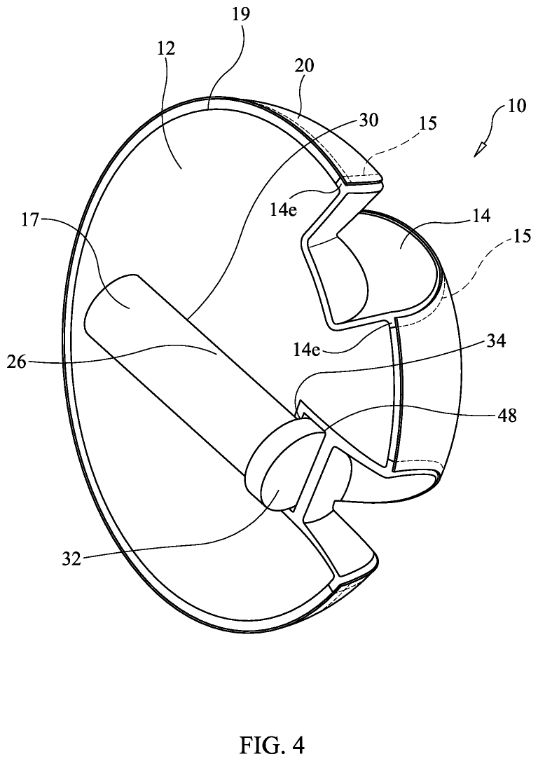

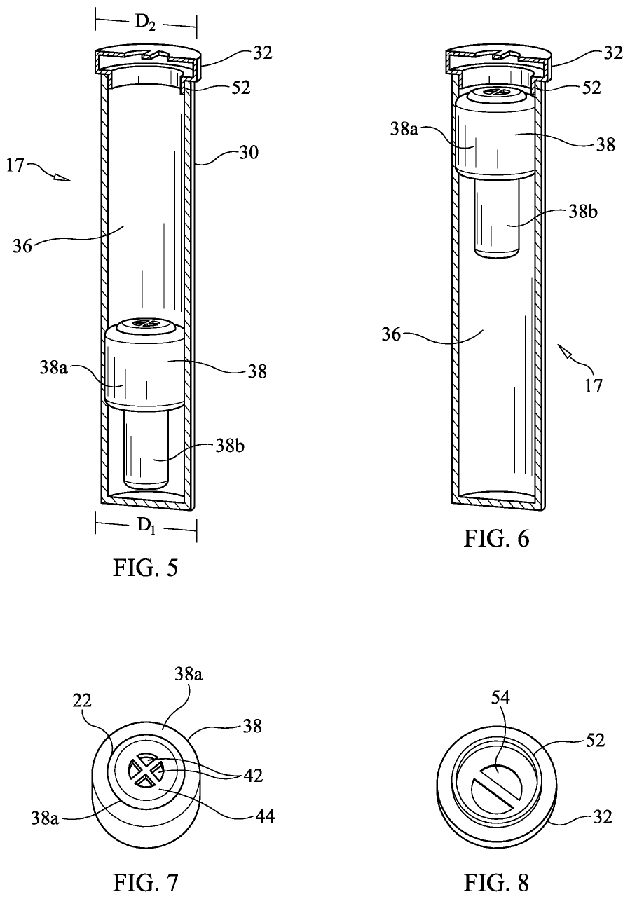

In the illustrated embodiment, the core 12 of the pet toy 10 is made of a first material. In this embodiment, the first material includes polyurethane foam. More preferably, the first material is polyurethane foam. In this embodiment, the channel assembly 14 is formed from a coating layer or material (see FIG. 5) is made of a second material that is different from the first material.

In one embodiment, the core 12 comprises an EVA core 12, but can be any compressible and pliable elastomeric foam that in this embodiment is generally spherical and has a channel recess. The core 12 is preferably generally solid with a cylindrical slot defining the interior portion 26. An elastomeric foam having a density in the range of 1.4 pounds per cubic foot (pcf) to 6.0 pcf is suitable for the core 12. As discussed above the core has a channel 28 that has the basic dimensions of the channel 18, that when combined with the channel assembly 14 forms the channel 18.

The core 12 can has a surface that is textured to help catch the channel assembly 14 or enable a secure attachment between the core 12 and the channel assembly 14. That is, the polyurethane core 12 preferably have micro dimples (not shown) that can receive the material of the channel assembly 14. However, the core 12 is preferably smooth to the naked eye.

As stated, the channel assembly 14 includes the second material that is applied to the core 12. In the embodiment illustrated in FIG. 3, the channel assembly 14 can be separately formed in a molding procedure so as to have a plurality of channel members 14a-14d. In this embodiment, the channel members are coupled to or adhered to the core 12 after formation of the core 12. The channel members can be adhered to the core 12 in any suitable manner included heating, adhesive or in any other suitable manner.

The channel assembly 14 can have the same basic configuration as the core channel 28, such that the combination of the core channel 29 and the channel assembly 14 form the configuration of the channel 18 described herein. Alternatively, the core channel 28 can be devoid of significant structure and have smooth walls and the channel assembly can form the configuration of the channel 18 described herein.

The second material can include elastic materials that can protect the core 12 from surface degradation, inhibit moisture vapor transmission, enhance aesthetics and to increase the impact and abrasion resistance of the pet toy 10. Examples of the second material that can form the channel assembly 14 include elastic materials such as acrylic, butyl rubber, chlorosulfonated polyethylene rubbers, polychloroprene rubbers, silicone polymer elastomeric coatings, polyurethane elastomer, modified asphalt, etc. In the illustrated embodiment, the first material has a first density, and the channel assembly 14 has a second density that is greater than the first density. That is, the channel assembly 14 can be denser than the core 12 in the illustrated embodiment.

As shown in FIGS. 4-8, the noise making device 17 is preferably a tubular member that includes a cylindrical tube or tubular member 30 and a lid 32 and can be a “giggle tube”. The tubular member 30 is a first portion with a first diameter Di and the lid 32 is a second portion with a second diameter Dz. The lid 32 is shorter than the tubular member 30. This configuration enables the noise making device 17 to be easily positioned within the interior portion 26 with the lid abutting a reduced diameter portion 34 in the core 12.

As shown in FIGS. 5-8, the tubular member 30 has a hollow interior 36 that has a generally consistent diameter, and can accommodate the noise maker 38. The noise maker 38 has a first portion 38a and a second portion 38b. The first portion 38a can be a metal ring that has an external diameter that is about the same size as the diameter of the hollow interior 36 of the tubular member 30. Thus the first portion 38a is capable of longitudinally sliding within the hollow interior 36 of the tubular member 30. That is, as illustrated in FIG. 6, the noise maker 38 can move longitudinally within the tubular member 30. The hollow interior 36 of the tubular member 30 has an opening 40 in the center thereof that is sized and configured to accommodate the second portion 38b. The second portion 38b is a cylindrical plastic member that is coupled to the first portion 38a. In one embodiment, the second portion 38b has a diameter that is substantially the same as the opening 40 in the first portion 38a and is fixed or attached to the first portion 38a via a friction fit or interference fit. However, it is noted that the first and second portions 38a and 38b can be coupled together in any manner desired.

The second portion 38b can have openings 42 in a top surface 44 thereof. The openings 42 are in communication with passages as is known in the noise making art, such that the passage of a fluid, such as air, will cause a noise to be made. Thus, as can be understood, when the noise maker 38 is movably disposed in the tubular member 30, the noise making device 17 is capable of making noise. More specifically, when the tubular member 30 is moved or titled, the noise maker 38 is configured to slide within the tubular member 30 by gravity. As the noise maker 38 slides along the hollow interior 36 of the tubular member 30, air passes through the second portion 38b resulting in a noise.

The lid 32 can have a flange portion 52 that is disposed within the hollow interior 36 of the tubular member 30. The flange portion 52 attaches the lid 32 to the tubular member 30 in any manner described including friction fit, adhesive and/or threads. The lid 32 can include opening 54 in the surface thereof to enable the sound from the noise maker 38 to be easily heard therethrough.

As illustrated in FIG. 4, the noise making device 17 is disposed within interior portion 26 of the core 12. The interior portion 26 of the core 12 can be a cylindrical slot that holds the noise making device 17 in place. The top 46 of the cylindrical slot 26 contains a channel 48 that holds the lid 32 of the noise making device 17 in position. This keeps the noise making device 17 in a secure location that dogs cannot access or destroy.

In one embodiment, the interior portion 26 is positioned along the central axis of the core 12 and/or the toy 10 itself. Such positioning protects the noise making device 17 by cushioning the noise making device 17 as much as possible. Moreover, as illustrated in FIG. 4 the interior portion 26 and the noise making device 17 extend over a majority of the diameter of the core 12. The interior portion 26 has an internal diameter that is substantially the same as the external diameter of the tubular member 30, which enables the noise making device 17 to be securely held within the cylindrical slot by a friction fit or interference fit. However, if desired the noise making device 17 can be held within the interior portion 26 using adhesives or in any other suitable manner.

The cover 16 in this embodiment can be fabric and comprise two (fabric) panels 16a and 16b that are sized and shaped to cover the outer portions of the core 12 demarcated by the channel assembly 14. Optionally, an adhesive or a double-sticky substrate can be disposed on the outer surface of the core 12, between the channel assembly and the core 12, and also between the panels 16a and 16b and the core 12, to fix the cover 16 and the channel assembly to the core 12. In a one embodiment, the substrate is heat activated. The substrate also provides additional protection for the core 12, to prevent the ingress of liquids and the like.

In the illustrated embodiment, the pet toy 10 is manufactured by a method comprising forming the core 12. In particular, the method can comprise forming the core 12 using a chemical foaming process inside an appropriate mold using an injection molding machine. As stated, the first polyurethane core 12 can alternatively be formed by extrusion, injection molding (e.g., reaction injection molding), blow and/or compression molding.

The noise making device 17 can then be inserted into the interior portion 26 of the core 12.

The channel assembly 14 is then separately molded into a plurality of channel members 14a-14d that are applied to the channel 28 of the core 12. The channels members 14a-14d are then adhered to each other and the core using heat. The cover 16 is then applied to the core 12. The cover 16 can be sewn or glued or adhered to the cover in any manner desired. Moreover, the cover 16 can be any suitable material desired. The cover 16 can be attached to the core 12, so as to overlie an edge of the channel assembly 14. This configuration protects the edge of the channel assembly 14 and the core 12.

In one embodiment, the cover 16 and the channel assembly 14 are stitched 15 together along the entire length of the channel member 14a-14d. Thus, as shown in FIG. 4, the 16 is sewn with stiches 15 onto flanges 14a of the channel assembly. Such a coupling of the cover 16 to the channel assembly 14 forms a secure connection therebetween.

In a particular method of construction, one of the panels 16a is split or formed in two portions (16a₁ and 16a₂), and the channel assembly 14 and cover 16 are assembled (e.g., by sewing) in an inverted configuration. The assembled cover 16 and channel assembly 14 is then wrapped around the core 12 with a heat-activated substrate 19 disposed therebetween, and the split panel (16a) is sewn together to fully enclose the core 12. The assembled pet toy 10 is then heated to activate the adhesive substrate, producing a very securely assembled pet toy 10 that is able to withstand long hours of rigorous play.

One of the channel members 14a-14d can include an opening 50 configured to correspond to the cover 32 of the noise making device 17. The opening 50 enables the noise from the noise making device 17 to emit from the toy and engage the animal. Moreover, as seen in the FIG. 4, the cover 32 of the noise making device 17 is disposed away from the bottom surface of the channel member 14a-14d, thus the noise making device 17 is protected from damage during use.

Thus, as can be understood, the core 12 in one embodiment is completely covered and protected cooperatively by the cover 16 and the channel assembly. Moreover, the cover 16 defines the outermost portion of the pet toy 10, and will therefore encounter substantially all of the direct contact with the environment during play. Therefore, the fabric component is formed from a tough and abrasion-resistant fabric, and is well configured to protect the other pet toy 10 components. The channel assembly is formed from a rubber, thereby providing superior gripping properties. In one embodiment, the exposed walls of the channel assembly are textured, to further enhance the gripping properties of the pet toy 10.

In another embodiment, the channel assembly 14 can include a second material that is liquid rubber that is applied and cured to the core 12. The second material is bonded to the first material inside a mold with appropriate heat and pressure using a compression molded machine. In this way, the channel assembly 14 is applied to the core 12. In the illustrated embodiment, the second material comprises the coating material 14. The second material can be an above-grade exterior coating that is thicker than paint that is also a flexible coating that helps waterproof the exterior of the pet toy 10. When the liquid rubber of the second material is applied to the core 12, the channel assembly 14 is formed, is cured, dried, hardened and bonded to the core 12, while remaining flexibility so that the pet toy 10 has a durable and a deformable structure that can retain its shape and consistency through multiple uses.

This embodiment further comprises forming the channel assembly 14 (e.g., the second material) by compression molding the rubber skin of the channel assembly 14 inside a mold using a rubber molding machine. The method further comprises applying the rubber channel assembly 14 over an exterior surface of the core 12. Therefore, the method further comprises bonding the channel assembly 14 to the core 12 inside a mold with heat and pressure using a compression molding machine. The method further comprises curing the rubber channel assembly 14 over the core 12.

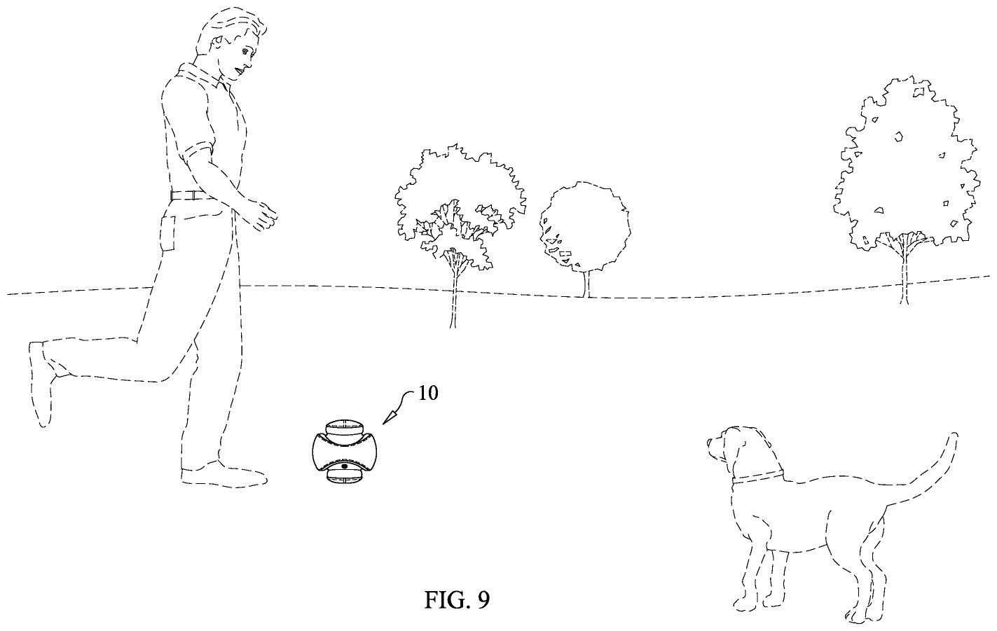

As shown in FIG. 9, during use, as the user kicks or an animal paws the pet toy 10 around, the internal noise making device 17 is configured to slide back and forth and emit a surprising giggle sound. As can be understood, the noise maker 38 should only slide within the tubular member 30 when the pet toy 10 is kicked in the direction parallel to the longitudinal axis of the noise maker 38. This makes the sound erratic and surprising. Animals will be surprised when the pet toy 10 suddenly emits a giggle noise. This new sound aspect will keep dogs engaged with the toy for long periods of time.

The embodiments of the present disclosure provide advantages not found in conventional pet toys. That is, the embodiments of the present disclosure are directed to a pet toy 10 formed from materials that enable the toy 10 to be suitable for indoor play and outdoor play. That is, the pet toy 10 is relatively soft, lightweight, and compliant for indoor play. Additionally, these embodiments are also directed to a pet toy 10 that will have enough mass to withstand at least light breezes, and have a relatively rugged outer surface for outdoor play.

The embodiments described herein also provide a pet toy that exhibits erratic or unpredictable behaviors. For example, embodiments described herein introduce chance into a game, or to develop and test a user's reflexes and reaction times. Similarly, embodiments described herein introduce erratic behavior when playing and/or training pets, both to keep the pet's attention and enjoyment of the game, and to keep the pet's reflexes sharp.

The embodiments described also provide a toy with sound. Specifically, the embodiments described provide exciting sounds that are needed to spark an animal's (e.g., a dog's) interest and encourage them to play.

### General Interpretation of Terms

In understanding the scope of the present invention, the term “comprising” and its derivatives, as used herein, are intended to be open ended terms that specify the presence of the stated features, elements, components, groups, and/or steps, but do not exclude the presence of other unstated features, elements and components, groups. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Accordingly, these terms, as utilized to describe the present invention should be interpreted relative to the pet toy.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. The functions of one element can be performed by two, and vice versa. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed:

1. A pet toy comprising:
a core having an interior portion and defining an elongate channel along a surface of the core;
a channel-shaped insert received into the elongate channel and overlying the elongate channel;
a cover attached to the channel-shaped insert, and overlying portions of the core that are not covered by the channel-shaped insert such that the core is enclosed cooperatively by the channel-shaped insert and the cover; and
a noise making device disposed within the interior portion of the core.

2. The pet toy of claim 1, wherein the noise making device is an elongate tube.

3. The pet toy of claim 2, wherein the noise making device includes a noise maker disposed within the elongate tube.

4. The pet toy of claim 3, wherein the noise maker includes openings in a surface thereof for the passage of air.

5. The pet toy of claim 3, wherein the noise maker includes a cylindrical plastic member with a ring.

6. The pet toy of claim 3, wherein the noise maker is configured to longitudinally slide within the elongate tube.

7. The pet toy of claim 3, wherein the noise maker is configured to move relative to the elongate tube due to gravity.

8. The pet toy of claim 1, wherein the noise making device includes a cover member.

9. The pet toy of claim 1, wherein the channel-shaped insert includes an opening and the noise making device is disposed at the opening.

10. The pet toy of claim 1, wherein the channel-shaped insert defines a spherical curve.

11. The pet toy of claim 1, wherein the cover comprises a plurality of woven panels.

12. The pet toy of claim 1, wherein the channel-shaped insert further comprises flanges, and the cover is attached to the channel-shaped insert by stitching to the flanges.

13. The pet toy of claim 1, wherein the cover is attached to the core with an adhesive.

14. The pet toy of claim 8, wherein the adhesive comprises a heat-activated adhesive substrate.

15. The pet toy of claim 1, wherein the channel-shaped insert defines a channel having a varying width.

16. The pet toy of claim 1, wherein the channel-shaped insert has a textured surface that improves the gripping properties of the insert.

17. The pet toy of claim 1, wherein the cover is a first color and the channel-shaped insert is a second color that is complementary to the first color.
